(19) United States
(12) Patent Application Publication
(10) Pub. No.: US 2004/0083326 A1
(43) Pub. Date: Apr. 29, 2004

(54) Switch scheduling algorithm

(76) Inventors: Yuanlong Wang, San Jose, CA (US); Libin Dong, Santa Clara, CA (US)

Correspondence Address: WEIDE & MILLER, LTD., 7251 W. LAKE MEAD BLVD., SUITE 530, LAS VEGAS, NV, 89128, US

(21) Appl. No.: 10/284,115

(22) Filed: Oct. 29, 2002

(51) Int. Cl. G06F 13/00

(52) U.S. Cl. 710/317

(57) ABSTRACT

A method and apparatus is disclosed for scheduling connections in a switch, such as an input-queued crossbar switch. In such an embodiment each input queue generates and provide requests for access to an egress port to a grant arbiter group. Each arbiter of the grant arbiter group grants a request from the two or more received request based on round robin scheduling of all available requests. Each of the grant arbiters notifies a accept arbiter group of the grants. Each arbiter in the accept arbiter group may receive more than one grant. Each arbiter in the accept arbiter group accepts a grant from the one or more grants received from the first arbiters based on least recently accepted scheduling. The accepted grants of the arbiters of the second arbiter groups control switch connections. In one embodiment the round robin scheduling and least recently accepted scheduling are updated after every iteration.

### FIELD OF THE INVENTION

The invention relates to communication and data switching and in particular to a method and apparatus to for scheduling traffic within a data switch.

### RELATED ART

Interface between communication or data networks (hereinafter networks) is essential to transmitting data between remote locations. To achieve the exchange of data between remote locations it may be necessary to transfer data contained on one network to another network. Thus, at a point of convergence, numerous networks may interface and thereby exchange data. As data travels to its destination it may pass through numerous points of convergence and over numerous networks.

Switches, such as crossbar switches have found wide application at points of convergences. Data, which may be segmented into cells, arrives at a switch and may be analyzed, queued, and presented to the switch. The switch may have numerous ingress ports and egress ports. During switching an ingress port may be connected to any one egress ports. Through selective control of the ingress-to-egress port connections, traffic may be selectively directed to different destinations to achieve desired data transfer. Numerous switch architectures include input queues that store port traffic prior to a switching event. Given the often unpredictable arrive rates of traffic to a switch, queues may develop a backlog of traffic bound for an egress port of the switch. Absent fair and efficient switch operation, switch decisions may treat certain ports unfairly by rarely achieving the requested switch connections. As a result certain queues or ports may remain permanently backlogged or blocked.

Numerous scheduling algorithms have been proposed to perform scheduling of switch connections in an effort to maximize switch throughput and reduce blocking or unfairness to certain switch ingress or egress ports. In short, the scheduling algorithm controls which ingress port will be connected to which egress port during each switching event.

One prior art switching algorithm is widely known as iSLIP. The iSLIP algorithm uses a rotating priority arbitration, i.e. round-robin, to match an ingress port with each egress port. The iSLIP algorithm may be thought of as a three step process whereby during a first step each ingress port sends a request to every egress port for which the ingress port has a queued cell. During a second step the egress ports receiving requests, grants an ingress port a connection based on which ingress port appears next in a fixed round-robin schedule and notifies the requesting ingress ports of the grant. During a third step, the ingress ports that received notification of a grant selects the grant based on which granting egress port appears next in a round-robin schedule. In this manner switch connects for a switching event are scheduled.

While iSLIP does achieve improved performance as compared to a system lacking a scheduling algorithm, it suffers from numerous drawbacks. One such drawback is that in situations when egress backpressure does exist, the iSLIP algorithm starves certain ports. Egress backpressure may be defined as an instance when a particular egress port is unavailable or when data to an egress port is halted. Upon occurrence of such events, a backpressure signal may be provided to the switch to accommodate the egress backpressure associated with the egress port. When presented with egress backpressure over numerous iterations, iSLIP tends to starve certain egress ports. This is a substantial drawback as it leads to reduced flow through the switch and reductions in bandwidth.

Another drawback associated with the iSLIP algorithm is that it can lose fairness to ingress ports when ingress congestion is present. In such a situation, ingress ports may be congested due to over subscription, which may result in loss of cells. In the event of congestion at an ingress port, the iSLIP algorithm operates with a higher probability that the egress port will select the same congested ingress ports during a switching event. This is often referred to as synchronization. As a result, the iSLIP selection process treats some input ports unfairly and a drop in performance will occur. Moreover, in some instances iSLIP is non-correcting in that the iSLIP algorithm does not de-synchronize and as a result the unfairness continues.

Hence, there is a need for an efficient and fair switch scheduling algorithm, even in the presence of backpressure and congested traffic, to overcome the drawbacks of the prior art.

### SUMMARY

A method and apparatus is disclosed for scheduling connections in a switch, such as an input-queued crossbar switch. In such an embodiment each input queue generates and provide requests for accessing an egress port to a first arbiter group, namely, grant arbiters. Each arbiter of the group of grant arbiters grants a request from the two or more received requests based on round robin scheduling of all available requests. Each grant arbiter notifies a second arbiter group of the grants. The arbiters in the second group are accept arbiters. Each accept arbiter in the second arbiter group may receive more than one grant. Each accept arbiter accepts a grant from the one or more grants received from the first arbiters based on a least recently accepted scheduling policy. The accepted grants of the arbiters of the second arbiter group control switch connections. In one embodiment the round robin scheduling and least recently accepted scheduling are updated after every iteration.

In one embodiment the invention provides a method for controlling switch connections in a crossbar switch with two or more input ports and two or more output ports. In this embodiment the method involves generating two or more request signals for access to an output port and providing these signals to two or more grant arbiters. Thereafter, selecting between the two or more request signals at each grant arbiter is based on round robin scheduling. The selecting between the two or more request signals generates a grant signal. Next, the method provides a grant signal from the two or more grant arbiters to each accept arbiter and selects between grant signals at each accept arbiter based on least recently used scheduling. In one embodiment the selecting between grant signals generates an accepted grant signal. The accepted grant signal is provided to a switch such that the accepted grant signal controls switch connections.

In one embodiment the grant arbiter comprises control logic and shift registers. In one embodiment the accept arbiter comprises control logic and shift registers. It is contemplated that in one embodiment only one grant signal may be provided from each grant arbiter and only one grant signal is selected by an accept arbiter. The switch may comprise a crossbar switch. In one embodiment the two or more request signals are generated by a virtual output queue when the virtual output queue contains data.

A method is also disclosed for selecting between granted requests provided to an arbiter in a switching system having two or more egress ports. This method comprises receiving two or more granted requests at the arbiter such that each granted request is associated with an egress port. This method determines which of the two or more egress ports was least recently used. The least recently used egress port may be designated with the highest priority. The method next accepts the granted request associated with the highest priority egress port and outputs a signal responsive to the accepting of the granted request.

In one embodiment this method further includes updating the least recently used status of the two or more egress ports in response to the acceptance of the granted request associated with the highest priority egress port. This occurs based on least recently used scheduling. It is further contemplated that the determining may comprise accessing a pointer value and that the arbiter may comprise an accept arbiter in a crossbar switch scheduler. In one embodiment the granted request comprises a signal indicating an ingress port's output queue that has been selected to transmit through the switch to an egress port.

When configured in conjunction with a switch, one embodiment of the invention comprises a switch having two or more input ports configured to receive data and two or more output ports configured to transmit data. Internal to the switch is a crossbar matrix configured to selectively connect an input port to an output port based on control signals. A scheduler is configured to generate the control signals to thereby determine which input port connects to which output port during a switching event of the crossbar matrix.

In one embodiment the scheduler comprises two or more queues configured to store data directed to one or more of the two or more output ports. A queue is configured to generate a request signal when data is stored in the queue. The queue may also include a grant arbiter configured to receive a request signal and select a request signal from two or more requests and output a grant signal indicative of the selected request signal. An accept arbiter is configured to receive two or more grant signals and generate a selected grant signal designating an output port based on least recently used arbitration.

In one embodiment the system may further include a decision register configured to receive a selected grant signal from the grant arbiter and output control signals to the crossbar matrix to control a switching event. In one embodiment the scheduler comprises an accept arbiter associated with each input port and a grant arbiter associated with each output port. It is contemplated that the request signal may comprise a signal from a queue associated with an output port to send data from the queue through the switch to an output port and a grant signal may comprise a signal from the grant arbiter indicating which output port was selected by the grant arbiter.

Another embodiment is configured as a switch scheduling system configured to control data flow through a switch by controlling switch connections between two or more inputs and two or more outputs. In this configuration the scheduling system comprises two or more queues such that at least one of the two or more queues is configure to store data and generate a request when data is stored in a queue. Also included is a memory configured to store a request from a queue to transmit to an output and a group of grant arbiters. Each of the grant arbiters is configured to receive request signals from the first memory and select a request based on round robin selection. In addition, each of the grant arbiters may be configured to output a grant signal representative of a queue associated with an output. A group of accept arbiters is included such that each of the second arbiters is configured to receive one or more grant signals from the group of first arbiters and select a grant signal based on least recently used selection policy. The selected grant signal represents the least recently selected queue. This embodiment may also include an interface module configured to receive the selections of the group of second arbiters and provide control signals to a switch.

In one embodiment at least one queue is associated with an output of the switch and at least one queue is configured as a first-in, first-out device. The first arbiter may be associated with each input and a second arbiter may be associated with each output. In one embodiment the switch comprises a crossbar switch and each of the two or more queues comprise virtual output queues such that each virtual output queue is associated with an output. In one embodiment the memory stores a request vector.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a block diagram of an example environment of operation for the invention.

FIG. 2 illustrates a block diagram of exemplary ingress and egress aspects of a switch.

FIG. 3 illustrates a block diagram of an exemplary embodiment of a switch.

FIG. 4 illustrates a block diagram of one embodiment of a scheduler.

FIG. 5A and 5B illustrate a block diagram of an example embodiment of a least recently used (LRU) arbiter.

FIG. 6A-6D illustrates exemplary one dimensional vectors illustrating exemplary least recently accepted scheduling priorities.

FIG. 7A & 7B illustrates an operational flow diagram of an example method of switch scheduling according to one embodiment of the invention.

FIG. 8 illustrates an operational flow diagram of an example method of arbiter operation based on least recently accepted scheduling.

### DETAILED DESCRIPTION

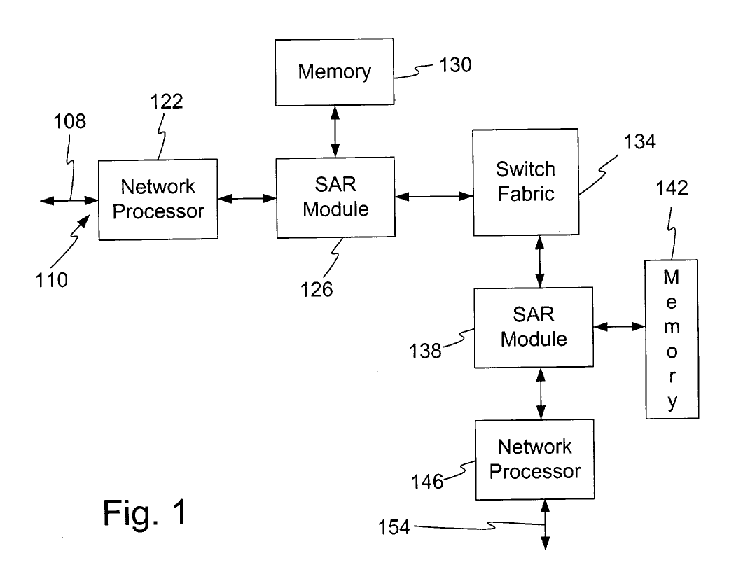

FIG. 1 illustrates a block diagram of an example environment for use of the switch control algorithm described herein. It should be noted that this is but one example environment of the invention. As understood by one of ordinary skill in the art, the invention may be utilized in other environments that are not shown.

In the example environment shown in FIG. 1, an input/output port 110 (I/O port) connects to a network processor 122 and channel 108, which in turn connects to a segmentation and reassembly processing (SAR) module 126. The SAR processing module 126 interfaces with a memory 130 and switch fabric 134.

Although shown as a single set of I/O processing hardware connected to a single port on the switch 134, it is contemplated that the switch may be enabled with any number of I/O ports. In one embodiment the switch includes sixty-four input and output ports. In another embodiment the switch includes one hundred forty-four input and output ports. The switch 134 also connects to a synchronous SAR module 138. The synchronous SAR module 138 interfaces with a memory 142 and network processor 146. The network processor 146 connects to one or more channels 154 configured to carry data.

The network processors 122, 146 are configured to achieve transmission of data, such as cells, frames, packets or the like, over a physical medium. The term cell is used herein to mean any amount or portion of data that is to be passed through a switch 134 or other interconnect device. In one embodiment cells are of uniform size to establish uniform switching transitions. A cell may include identifier data, such as a tag, header or other associated information for use in routing or queue of the cell. The network processors 122, 146 may include all aspects necessary to connect to a transmission medium 108, 154. The network processing modules 122, 146 may be configured in hardware, software, or a combination thereof. In one embodiment the network processor 122, 146 comprises a processor or configuration of logic and memory configured to perform header or tag analysis and processing on incoming or outgoing frames, cells, or containers. In one embodiment the network processor 122, 146 may provide routing decisions for attachment to a cell or for the switch fabric 134. One example of a network processor 122 is an Application Specific Network Processor (ASNP) available from Conexant Systems in Newport Beach, Calif. The network processors 122, 146 may include a CAM or other memory device configured to store route or switch control information.

In one embodiment the SAR 126, 138 comprises a device configured to segment packets into cells and reassemble cells into packets. It may further be responsible for maintaining cell ordering, i.e. cell sequence. It is contemplated that the SAR 126, 138 includes one or more memories and one or more pointers configured to track one or more locations in the one or more memories. In general, the SAR 126, 138 arranges the data into cells or frames of a size suitable for switching through the switch fabric 134. After passage through the switch fabric 134, the SAR 126, 138 reassembles the cells (frames) into a format for transmission over a medium 108, 154. The memory 130, 142 in communication with the SARs 126, 138 may comprise any type of memory including but not limited to RAM, SRAM, SDRAM, or DRAM, DDRAM or any other type of memory capable of rapidly storing data or retrieving data.

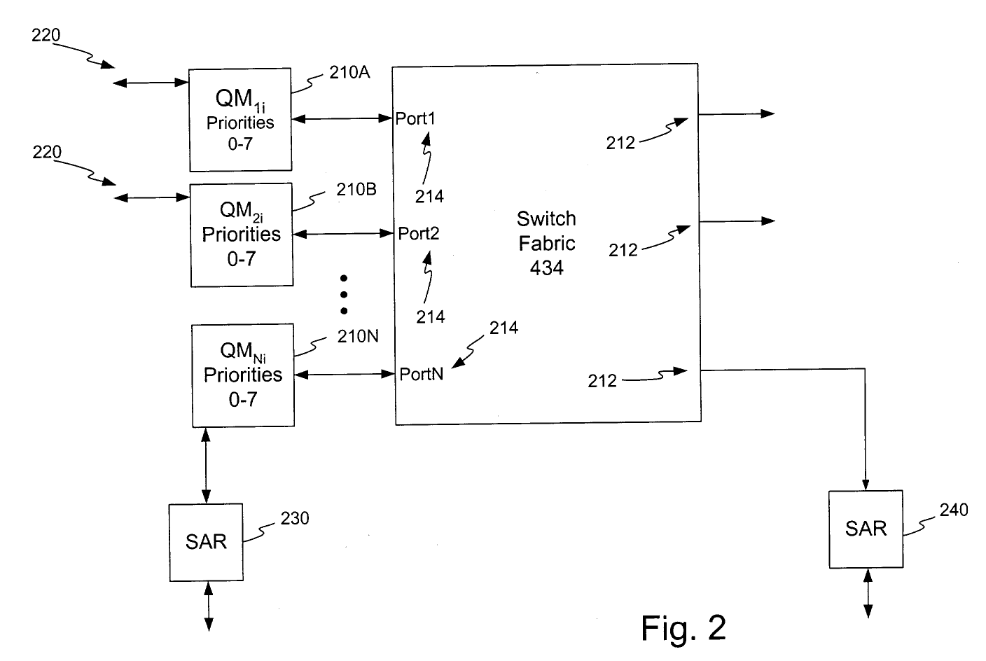

FIG. 2 illustrates a more detailed block diagram of a switch fabric 434 with an exemplary connection to a segmentation and reassembly unit 230, 240. It is contemplated that the switch fabric 434 may connect to one or more queue managers 210A-210N via ports 214. The queue managers 210 are designated QM₀₋ₙ and there may exist a queue manage for each of the input ports 214. In one embodiment N=63 for a total of 64 input ports and 64 output ports. In other embodiments, N may comprise any positive integer.

Further, there may be numerous VOQ (virtual output queues) associated with each queue manager 210 thereby creating a plurality of sub-queues. In one embodiment there exists a virtual output queue (VOQ), in each queue manager 210 for each output port of the switch 434. In another embodiment there exists a VOQ for each of the different priorities. In one embodiment eight priorities exist for each queue manager 210. In another embodiment there exists only one priority for the queue manager queues. In one embodiment the number of VOQs is determined by the number of output (egress) ports times the number of priorities. For example, in one embodiment each input port may be configured with a queue manager and within each queue manager there exists a queue, such as a VOQ, for each output port. Cells arriving at each queue manager 210 may be assigned a particular VOQ. In another embodiment, the switch 434 may be configured with one hundred forty-four inputs and one hundred forty-four outputs. Any switch configuration is contemplated.

Accordingly, it is contemplated that the queue managers 210 may include one or more memories, configured as queues, to store incoming and outgoing frames or cells. In one embodiment each queue of the queue manager 210 comprises a first-in, first out (FIFO) device. In the exemplary embodiment shown in FIG. 2, each queue manager 210 has eight priority queues for each output port. Other configurations may have other numbers of queues within each queue manager. Hence, for a 64 port switch, with 8 priorities per port, there exist 512 queues within each queue manager.

Connected to each queue manager 210 are one or more I/O channels 220. Traffic may arrive through these channels 220 for processing by the switch 434 to achieve desired routing or connection. Connecting to one or more of the queue managers 210, such as 210N, is a first SAR unit 230. A second SAR unit 240 connects to one or more of the outputs 212 of the switch 434.

It is contemplated that in one embodiment the traffic arriving over SAR unit 230 may arrive in an asynchronous manner and that output via the SAR unit 240 may occur in a synchronous manner. Hence, bursty traffic may be arriving at irregular intervals at the SAR unit 230 and it may be desired to output this traffic onto a network operating and transmitting data in a synchronous manner. In addition, it may be desired to fully utilize the channel capacity of the synchronous network. In other embodiments the input and output to SAR units 230, 240 operate either synchronously or asynchronously in any combination.

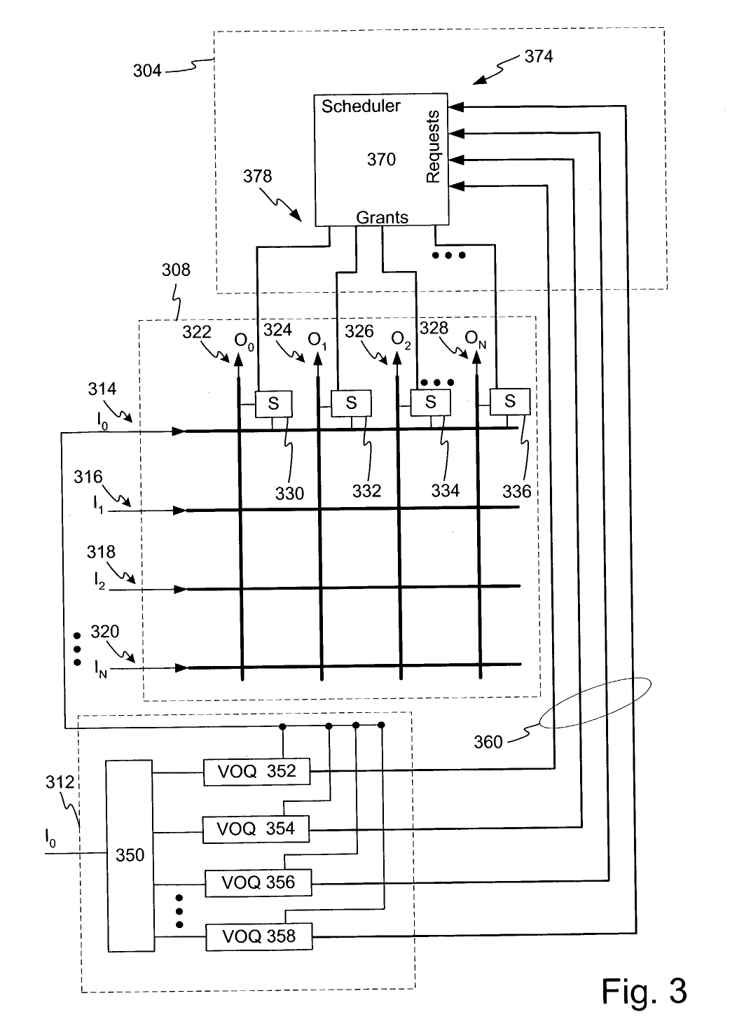

FIG. 3 illustrates a block diagram of an example embodiment of a crossbar switch having virtual output queues and a scheduler. For purposes of understanding the system, FIG. 3 may be sub-divided into three sub-systems comprising a scheduler subsystem 304, a crossbar subsystem 308, and virtual output queues 312. These three sub-systems operate together to switch data through a switch while avoiding some of the drawbacks associated with the prior art.

In reference to the crossbar 308, a plurality of inputs I₀-I_{N} 314-320 are configured to receive data, such as cells, to be passed through a switch to a destination served by one or more of a plurality of outputs O₀-O_{N} 322-328. In this example the variable N may comprise any integer greater than or equal to two.

At each junction of input lines 314-320 and output lines 322-328 is a switching element 330-336. The switching elements 330-336 control which input lines 314-320 are connected to output lines 322-328. It is contemplated that although only the switching elements 330-328 for the first input 314 are shown, a switching element would be associated with each potential connection point between inputs 314-320 and outputs 322-328.

The switching element 330-336 may comprise any device capable of connecting two or more lines or conductors in response to a control signal or other input intended to selectively determine which input 314-320 connects to which output 322-328. Accordingly, in one embodiment each switching element 330-336 may include an input configured to receive a control signal from the scheduler 304. This control signal is discussed below in more detail.

Also shown in FIG. 3 is the virtual output queues (VOQ) subsystem 312. The VOQ subsystem 312 comprises a queue manager 350 connected to a plurality of virtual output queues (VOQ) 352-358. The queue manager 350 may be configured to analyze a cell identifier or tag to determine the destination port of the cell. In one embodiment the VOQs 352-358 comprise first-in, first-out memory. In one embodiment, there exists a VOQ 352-358 for each output 322-328. In one embodiment there exists a virtual output queue (VOQ) subsystem 312 associated with each input 314-320. As shown, the queue manager 350 receives cells (inputs) directed to input I₀ 314 and analyzes the cells to determine into which output queue 352-358 the received cell should be placed. For example, a cell destined for the first output 322 would be placed in VOQ 352.

The output of each VOQ 352-358 connects to input 314. Hence, the next-out content of each VOQ 352-358 may be selectively provided to the input 314. Similar structure and capability may be provided for the other inputs 316, 318, 320. Thus each input 314-320 possesses an associated subsystem 312. An additional output from each VOQ 352-358 connects to the scheduler subsystem 304 via conductors 360. In one embodiment the signal that pass via conductors 360 comprise a request presented to the scheduler subsystem 304. The requests from the VOQ subsystem 312 comprise a signal that indicates when a VOQ has content, such as cells, stored for output to a particular output line 322-328.

The scheduler subsystem 304 comprises a scheduler 370 configured with inputs 374 to receive request signals from the VOQ sub-system 312 and outputs 378 configured to send grant signals to switching elements 330-336 in the crossbar subsystem 308. The scheduler 370, which is described below in greater detail, operates to selectively determine which switching elements 330-336 are enabled to connect an input line 314-320 to an output line 322-328 during a switching event. In the embodiment shown in FIG. 3, the scheduler 370 adopts least recently used scheduling for at least part of the scheduling and may update the scheduler 370 during every iteration of the scheduling process. These concepts are described below in more detail.

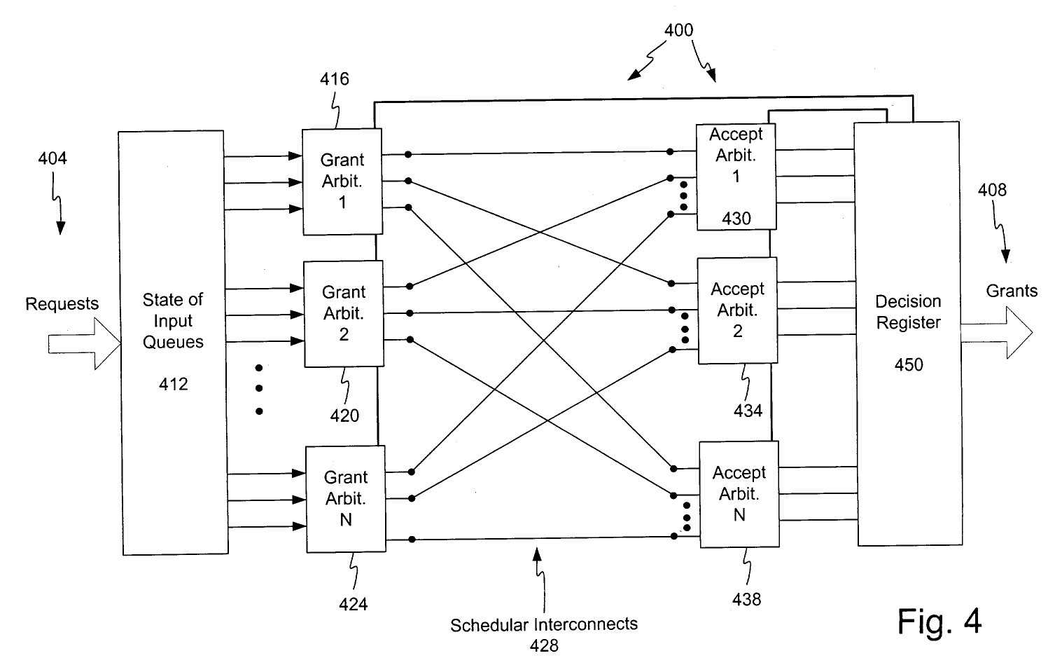

FIG. 4 illustrates a more detailed block diagram of the scheduler shown in FIG. 3. In one embodiment scheduler 400 is configured to receive a plurality of requests 404 and, as a result of processing, output one or more grants 408. In one embodiment the grant and a request comprise signals. In one embodiment, a request comprises a signal or other indicator from an input line or queue, such as a virtual output queue, that the input line or queue has a cell intended for an output port of the switch. In one embodiment the scheduler 400 includes N² number of inputs such as request 404, wherein N represents the number of inputs and the number of outputs to the switch. Hence, if the scheduler were configured for use with a 144×144 crossbar switch, then N would equal 144. It is contemplated that for each input to the switch, there exists a request input line for each potential output from the switch. In one embodiment the requests, may comprise logic values, generated by each VOQ that has a cell queued to be output via an output port of the switch. Hence, a request may be considered as a request to gain access to an output port of the switch.

The requests 404 connect to a memory 412 configured to store the state of each request. In one embodiment the state comprises a logical one or a logical zero. This may be considered a request vector. The memory 412 outputs the requests to grant arbitrators 416, 420, 424. In one embodiment there exists a grant arbiter for each of the inputs to the switch. Hence, grant arbiter 416 is associated with the first input I₀ as shown in FIG. 3. In addition, each grant arbiter 416, 420, 424 includes an output connected to an input of an accept arbiter 430, 434, 438. The outputs of the grant arbiters 416, 420, 424 carry granted request signals to the appropriate accept arbiters 430, 434, 438. The granted request signal travel through scheduler interconnects 428. The grant arbiter 416, 420, 424 comprise devices configured to select, i.e. grant, a request from one or more requests and output the grant to an accept arbiter 430, 434, 438. In one embodiment the grant arbiters 416, 420, 424, select (grant) a request based on round robin scheduling. The grant arbiters 416, 420, 424 may comprise memory units, control logic, a combination thereof, or another device, system of software configured to function as described herein. One example embodiment of grant arbiters 416, 420, 424 are described and illustrated in U.S. Pat. No. 5,500,858 issued to McKeown, Ser. No. 359,890, which is incorporated in its entirety herein by reference. Also incorporated by reference herein is the article The iSLIP Scheduling Algorithm for Input-Queued Switches written by N. McKeown and published in IEEE/ACM Transactions on Networking, Vol. 7, No. 2, April 1999. The grant arbiters are known in the art and accordingly not described in great detail herein. To aid in the understanding of the operation of the system described herein the grant arbiter's 416, 420, 424 general operation in conjunction with the other systems are discussed below in more detail.

The accept arbiters 430, 434, 438 comprise devices configured to receive the grantes generated from the grant arbiters 416, 420, 424 and, for each accept arbiter 430, 434, 438, accept one of the grants. The accept arbiters 430, 434, 438 further include outputs connected to a decision register 450. In one embodiment an output from each accept arbiter 430, 434, 438 to the decision register 450 exists for each grant arbiter output. In one embodiment, the accept arbiter 430 may receive requests from any or all of the grant arbiters 416, 420, 424. In one embodiment the accept arbiter 430 may accept one of these requests based on the accept arbiter scheduling algorithm. In one embodiment the accept arbiter scheduling algorithm is based on a least recently used priority for accepting requests. This is discussed below in greater detail. Upon receiving a grant, the accept arbiter 430, 434, 438 accepts or selects a grant from the grant arbiters 416, 420, 424 received over the scheduler interconnects 428. It is contemplated that an accept arbiter 430, 434, 438 may receive more than one grant, i.e. a request granted by the grant arbiter 416, 420, 424. In one embodiment each accept arbiter only accepts one granted request. This completes an iteration of the operation of the scheduler 400. As a result of this iteration, the accept arbiters 430, 434, 438 and grant arbiters 416, 420, 424 have matched an input line, having queued cells, to an output line. Numerous iterations may occur based on these principles in an effort to increase the number of matches between input lines, having queued cells, to an output line.

Multiple iterations may increase the number of input-to-output connections that occur during a switching event. During each iteration or after the final iteration, the accept arbiters 430, 434, 438 and grant arbiters 416, 420, 424 may output the input-to-output line connects to the decision register 450. The decision register 450 comprises memory or other storage medium configured to collect and output as grants the input-to-output line connections as determined by the one or more iterations described above. The grants are output to the switching elements (FIG. 3) of the crossbar switch to control which input lines are connected to which output lines. In one embodiment there exist N² output lines configured to carry the grants. In one embodiment the grant signals comprise logic one and logic zero values.

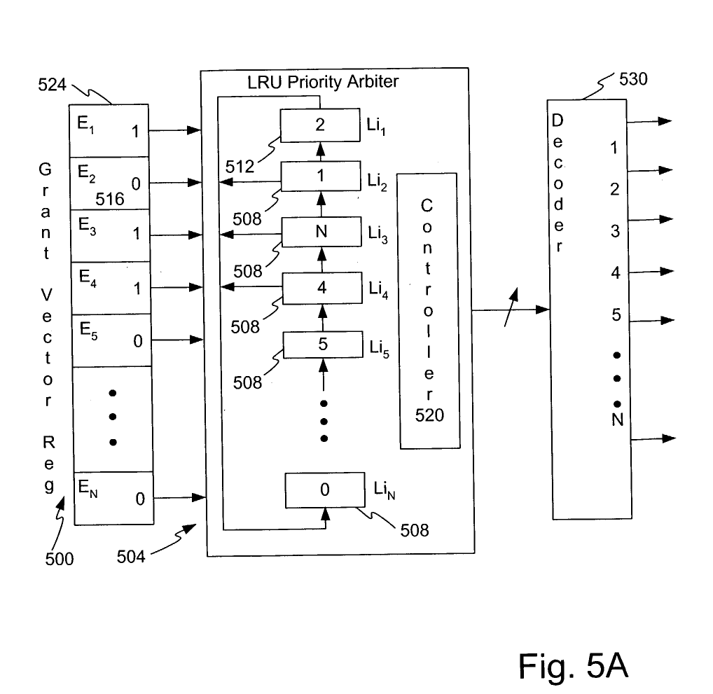

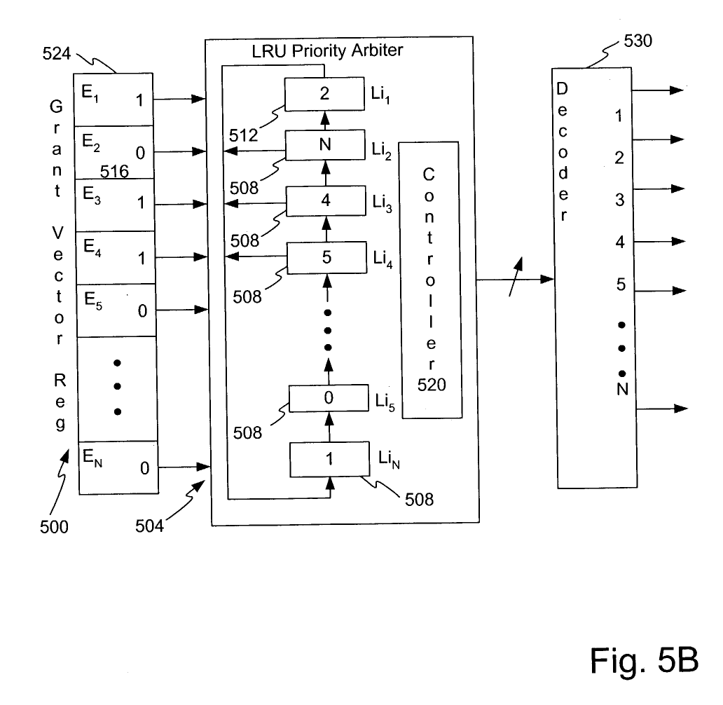

FIG. 5 illustrates a block diagram of an example embodiment of a least recently used arbiter. In one embodiment the least recently used arbiter is configured as part of an accept arbiter to determine which granted request is selected from a possible plurality of requests. The arbiter shown in FIG. 5 comprises a grant vector register 500 configured to receive and store a grant vector. The grant vector register 500 may comprise any memory or storage device configured to store one or more signals or data values. In this embodiment, there exists inputs Iᵢ where there are inputs I₀-I_{N}. In the embodiment shown in FIG. 5A, the grant vector register 500 is N bits in length where N corresponds to the number of egress ports in the system and each bit of the vector indicates whether the corresponding egress port sent a grant to the specific ingress port Iᵢ. Identifiers E₁-E_{N} are used to show this correlation. In the example shown in FIG. 5A, egress port 1, 3, 4 send 3 grants to this ingress port shown by the corresponding 1 logic values stored in the 1st, 3rd and 4th positions of the grant vector register 500.

The grant vector register 500 includes outputs that connect to the LRU priority arbiter 504. The LRU priority arbiter 504 comprises hardware, or software, or both configured to track which of a plurality of entries was the least recently utilized or selected. In one embodiment the LRU priority arbiter 504 comprises a memory unit and associated control logic. In the embodiment shown in FIG. 5A, the LRU priority arbiter 504 includes two or more LRU pointer registers, L_{i,1}, L_{i,2}, . . . , L_{i,N}, where L_{j,i} indicates the egress port of the j^{th} highest priority.

In one embodiment there comprises N number of LRU pointer registers 508, 512 where N equals any positive whole number. In one embodiment each LRU pointer register 508, 512 is of width log₂N. In one embodiment the N LRU pointer registers 508, 512 are structured as shift registers. In other embodiment storage devices other than registers may be utilized such as but not limited to RAM, SRAM, DRAM, or any other type of memory structure.

In the example shown in FIG. 5A, pointer register L_{i,1} 512 has a value of 2, meaning that egress port 2 is the least recently used, and thus has the highest priority. However, only egress port 1, 3 and 4 sent a grant signal to the LRU priority arbiter 504. Egress port 2 516 did not send a grant signal to the LRU priority arbiter 504. Thus, of the egress ports that sent a grant signal to the LRU priority arbiter 504, the LRU pointer registers 508 show that egress port 1 516 has the highest priority. Stated another way, among the three egress ports that sent the three grants, the egress port 1 516 has the highest priority, as shown by the content of register Lᵢ₂

Continuing with this example, the LRU priority arbiter 504 would accept the grant from egress port 1, and send out the result 1 to a controller 520. The controller 520 outputs a value comprising one or more up to log₂N signals indicating the number of egress ports whose grant was accepted. After the LRU priority arbiter 504 accepts a specific grant according to the information in the grant vector register 500 and the status of the LRU pointer registers 512, 508, it adjusts the LRU pointers 508, 512 based on the most recently used selection, i.e. in this example egress port 1 524. In this example, since egress port 1 was selected, egress port 1 will become the one with the lowest priority, and the priorities of the other egress ports that originally had lower priority than egress port 1 will be increased. Thus, the value of the LRU pointer register L_{i,2} is shifted into the register L_{i,N}, and the values of the registers following L_{i,2} are shifted up. The result of the LRU pointer adjustment is shown in FIG. 5B.

The acceptance result from LRU priority arbiter 504, and in particular the controller 520, is sent to a decoder 530. The decoder 530 comprises a simple hardware logic unit, such as a MUX or any other device capable of decoding. The decoder is known by one or ordinary skill in the art and hence not described in detail herein. In one embodiment the decoder 530 takes a binary value in the range of [1, N] from the log₂N input lines and generates the decoded result at the N output lines. In one configuration this results in the outputs of the decodes 530 that, which corresponds to a selected output value being set to ‘1’, while the other output lines are set to ‘0’. In the example shown in FIG. 5A, since the system chooses the grant from egress port 1, the output of the decoder 530 has its first output line set to ‘1’, and all the other output lines set to ‘0’. The output of the decoder 530 may connect to the N egress ports.

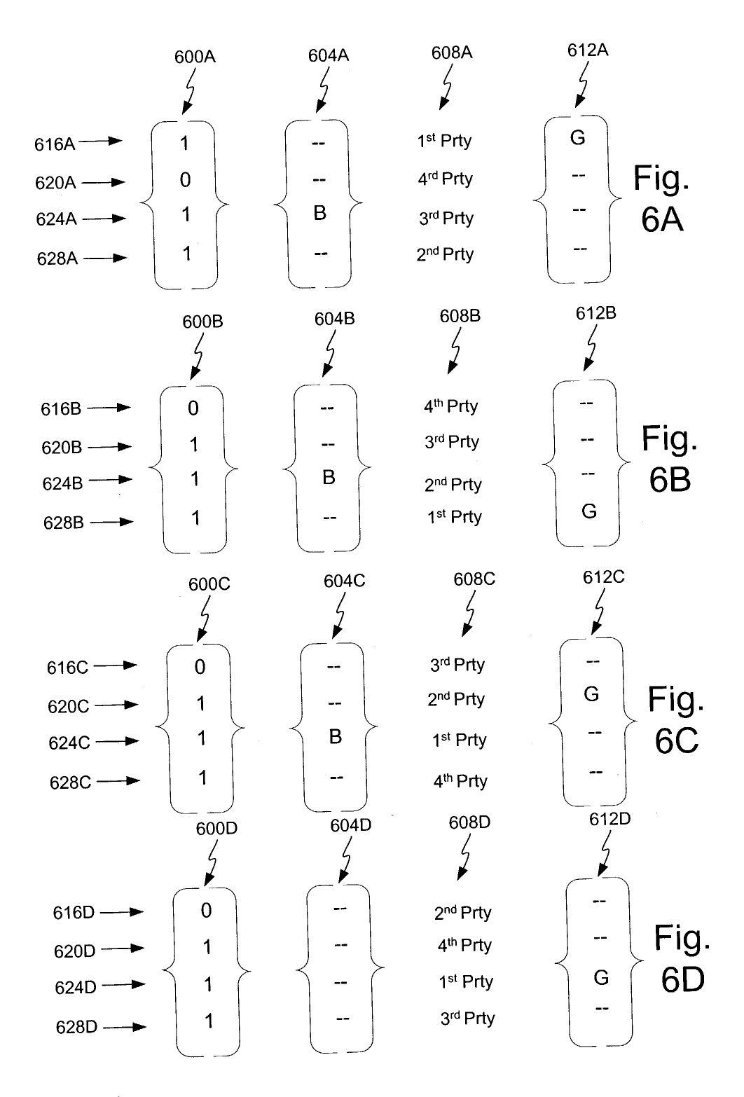

FIG. 6A-6D illustrates exemplary operation based on grant vectors presented to an accept arbiter configured to perform least recently used scheduling. As shown a grant arbiter output vector 600 represents an exemplary output from a grant arbiter, such as grant arbiter 416 (FIG. 4). In one embodiment the grant arbiter output vector 600 indicates which virtual output queues have cells queued for output through a port. In this example embodiment there exist four output ports. Hence, there exist four vector values 616, 620, 624, 628. Each position in the vector corresponds to a output port. Hence, a one value at position 616A of the grant arbiter output vector 600A indicates that the first input has a cell queued for output to the first output port.

A blocking vector 604 represents which of the output ports are congested or not accepting cells for output. The variable B in the blocking vector indicates a congested port. For example, a position 624A is blocked in the blocking vector 604A. The priority indicators 608 indicate the priority of positions 616, 620, 624, 628. Thus, in FIG. 6A, position 616A has higher priority than the other positions. In one embodiment, priority is assigned based on a least recently used basis.

Accept vector 612 represents the outcome of the accept arbiter operation. For example, the accept vector 612A indicates that position 616A was accepted since it had a grant in the grant vector 600A and the highest priority in priority vector 608A.

Operation of several iterations are now shown in FIGS. 6A-6D. During a first iteration shown in FIG. 6A, a grant vector 600A shows that grants have been sent to the accept arbiter for positions 616A, 624A, and 628A and therefore the grant arbiter sending vector 600A has cells queues for outputs 1, 3, and 4. Blocking vector 604A indicates that the third output is blocked. Since priority vector 608A assigns highest priority to position 616A, the accept selection occurs at position 626A of the accept vector 612A.

Thereafter, and as shown in FIG. 6B, during a second iteration or during a second switching event the grant vector 600B is presented to the accept arbiter as is the blocking vector 604B. As can be seen, the priority vector 608B has been adjusted as a result of the iteration shown in FIG. 6A. Lowest priority is assigned to position 618B while highest priority is assigned to position 620B. Accordingly, the accept arbiter selects the fourth position 628B in the accept vector 612B. In one embodiment this results in a request generated by a cell queued in a VOQ and destine for the fourth output being accepted.

Moving to FIG. 6C, the priority vector 608C is adjusted based on a least recently used ordering. Accordingly, position 628C, which was accepted in the operation of FIG. 6B, is assigned the lowest priority while position 616C is adjusted to have the second to the lowest priority. The highest priority is assigned to position 624C. The blocking vector indicates that output position 624C is receiving a blocking signal. Hence the third output is not available. As a result, the position with the highest priority is not accepted and the availability of the next highest priority is determined. In FIG. 6C, the next highest priority is position 620C and as indicated by the grant vector 600C, there exists a queued cell in position 620C. Accordingly, the accept arbiter accepts the request of position 620C as shown by the accept vector 612C.

At FIG. 6D, it can be seen that based on least recently used principles, the priority vector 608D has been adjusted to reflected that the previously accepted position 620D has the lowest priority while the highest priority position remains at position 624D. Hence, the accept vector 612D accepts position 624D. In this manner the least most recently used selection method for the accept arbitrator prevents starvation or unfairness to a particular output port or VOQ.

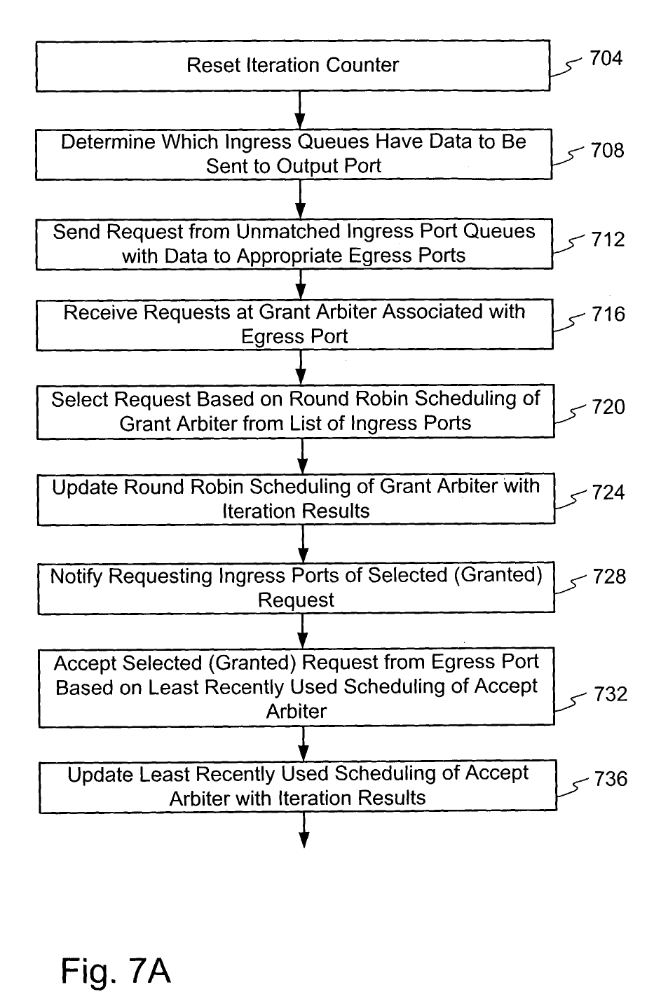

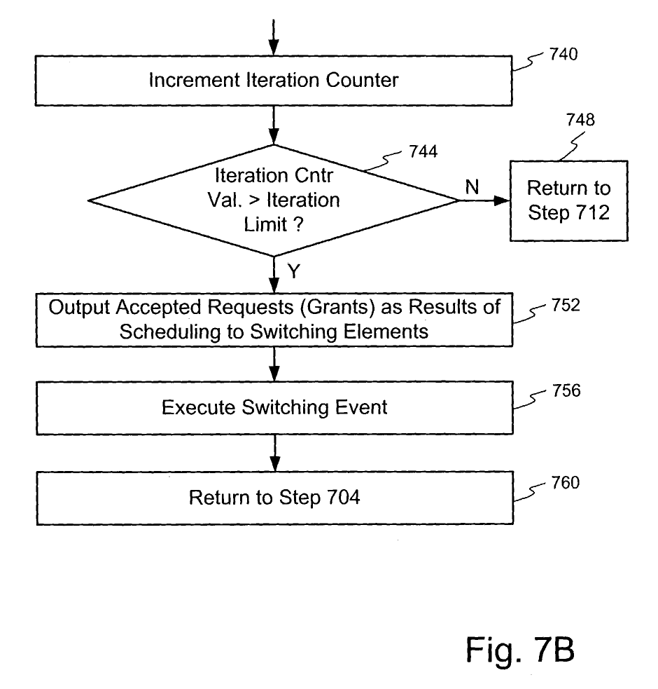

FIG. 7 illustrates an operational flow diagram of an example method of operation of a scheduler. The scheduler may be found in a crossbar switch. This is but one possible method of operation and hence the scope of the claims that follow should not be interpreted to be limited by this exemplary method of operation. In one embodiment, the method shown in FIG. 7 is associated with the scheduler shown in FIG. 4. It is contemplated that the scheduling algorithms discussed herein maybe repeated more than once. Thus, in one embodiment, the scheduler may be configured to execute numerous iterations of the request, grant, accept operations as described herein. During each iteration additional input port to output port matches may occur thereby increasing the throughput of the switch. To initiate a scheduling process and at a step 704, an iteration counter is reset. In one embodiment, the iteration counter may be reset after each switching event.

Next, at a step 708, the operation determines which ingress queues contain data, such as cells, to be sent to an output port of a switch. In one embodiment a queue manager or individual signals from ingress queues control this process. In one embodiment the ingress queues comprise virtual output queues. Thereafter, at a step 712, the operation sends a request from each unmatched ingress queue with one or more queued cells to the corresponding egress port. In one embodiment the requests are sent to a grant arbiter. In one embodiment the request comprises a signal seeking permission to send data from a virtual output queue to a particular output port of a switch.

At a step 716, a grant arbiter associated with each egress port receives the requests. It is contemplated that each grant arbiter may receive more than one request. Thereafter, at a step 720, the grant arbiter selects a request based on round robin scheduling that occurs within the grant arbiter that receive requests. The round robin scheduling is updated at step 724. Round robin scheduling is known in the art and accordingly not described in great detail herein. In one embodiment a pointer to a memory location is updated as part of the round robin scheduler update. The pointer may be defined by a counter value. As an advantage over the prior art, the round robin scheduling may be updated after each request selection process or after each iteration. This leads to a more fair scheduling algorithm than systems of the prior art.

At a step 728 the operation notifies the requesting ingress ports of which grant has been accepted. In one embodiment the notification is not sent to the ingress port but to a subsequent scheduling stage. In one embodiment an accept arbiter may receive the notification, which may comprise the granted requests, and each accept arbiter may accept one of the granted requests. The determination as to which granted request to accept at the accept arbiter may be based on a least most recently used basis. This occurs at step 732. Thus, the accept arbiter accepts the request from the ingress port that was the least recently selected. This provides an advantage over the prior art of reducing starvation and improving fairness in scheduling.

At a step 736 the operation updates the least recently used scheduling of the accept arbiter with the iteration results. Updating the least recently used scheduling algorithm after every iteration provides an advantage over the prior art of reducing starvation and improving fairness in scheduling in addition to the advantages discussed above.

At a step 740 shown on FIG. 7B, the operation increments an iteration counter. It is contemplated that a limited number of scheduling iterations are possible between switching events. The number of iterations may be limited by the time between switching events. At a decision step 744 the operation determines if the iteration counter value is greater than an iteration limit. The iteration limit may comprise a predetermined value representing the maximum number of scheduling iterations that may occur between switching events.

If at step 744 the iteration counter value is not greater than the iteration limit than the operation returns to a step 712 and the scheduler executes another iteration in an effort to match addition ingress queues with an output port. Alternatively, if at step 744 the iteration counter value is greater than the iteration limit then the operation advances to step 752. At step 752 the operation outputs the accepted requests, i.e. grants, that were generated as a result of the scheduling operation. In one embodiment the grants are provided to switching elements in a crossbar switch to control input output connections. Thereafter, at a step 756, the operation executes a switching event based on the scheduling process described above. In one embodiment, the switching event comprises a connection of at least one input to at least one output. As can be understood the connections between inputs and output is controlled by the scheduling described above. Unfair scheduling or scheduling that starves an input port or output port is undesirable as it leads to unfair port selection, reduces bandwidth, or denies QOS. The method and apparatus described herein prevent starvation and unfairness. At a step 760, the operation returns to a step 704 and the operation may repeat.

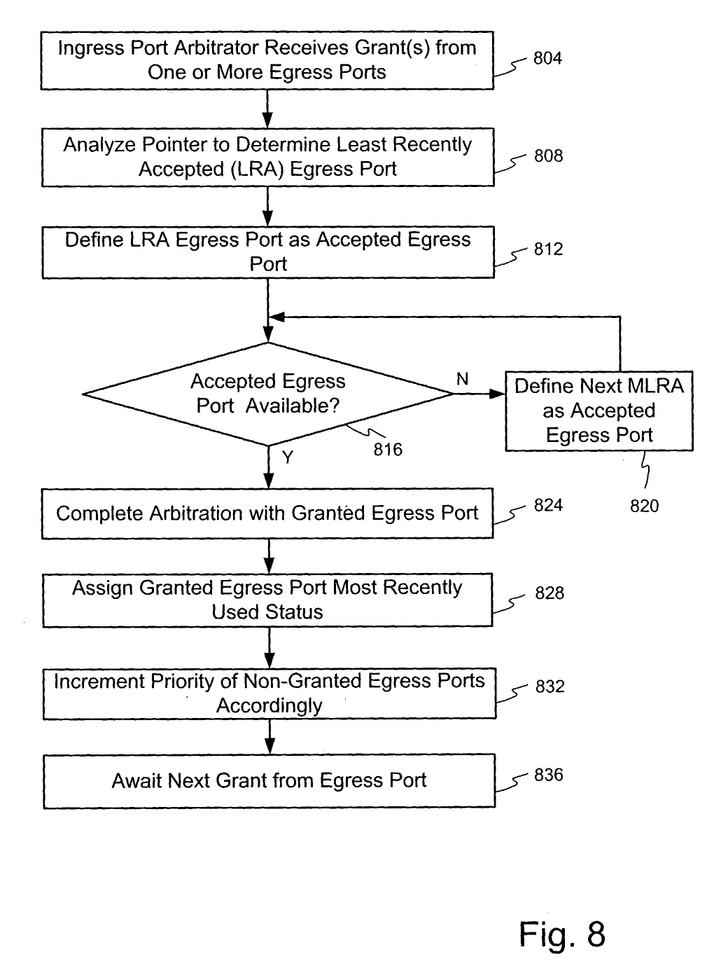

FIG. 8 illustrates an operational flow diagram of an example method of least recently used scheduling. This example embodiment is provided for purposes of discussion as it is contemplated that other methods of least recently used scheduling may be adopted without departing from the scope of the invention. In one embodiment this method may be considered part of a third step in a three step scheduling operation. In reference to FIG. 8, at a step 804, an ingress port arbiter receives one or more grants from one or more egress ports. In one embodiment the ingress port arbiter comprises an accept arbiter. It is contemplated that the ingress port arbiter may receive more than one grant and hence it may select one of the more than one grants. Stated another way, the ingress port arbiter must select an egress port with which to match the ingress port.

Next, at a step 808 the operation analyzes a pointer value or other identifier to determine the least recently used (LRU) egress port. In one embodiment a LRU priority arbiter determines the least LRU port. The determination is advantageously made based on which egress port was least recently accepted by the particular ingress port arbiter. This reduces starvation to a particular port, which in turn promotes fairness and reduces head of line blocking.

At a step 812 the operation defines the least recently used egress port as the accepted egress port. Thereafter, at a decision step 816, a determination is made regarding whether the accepted egress port is available. It is contemplated that an egress port may become unavailable for a number of reasons, including but not limited to, a device failure, congestion, or bandwidth limitations. If the accepted egress port is unavailable, then the operation advances to a step 820. At step 820, the operation defines the next most least recently accepted (Next MLRA) egress port as the accepted egress port. Hence the operation advances or adjusts a pointer or other indicator according to a least recently used scheduling to account for an unavailable egress port. After step 820 the operation returns to decision step 816.

Alternatively, if at step 816 the accepted egress port is available, then the operation advances to step 824 and the arbitration process formally accepts the egress port. Thereafter, and according to the least recently used scheduling, the operation assigns the accepted egress port the most recently used status. This occurs at a step 828. Thus, the most recently used port becomes the lowest priority port since it was most recently used. At a step 832 the operation increments the priority of other non-granted egress ports according to least recently used scheduling. This may comprise adjustment of numerous values or a single pointer or other identifier. Thereafter at a step 836 the ingress port arbiter, such as an accept arbiter, awaits the next grant from an egress port, so that this least recently used arbitration may repeat.

While various embodiments of the invention have been described, it will be apparent to those of ordinary skill in the art that many more embodiments and implementations are possible that are within the scope of this invention.

What is claimed is:

1. A method for controlling switch connections in a switch having two or more input ports and two or more output ports, the method comprising:
providing two or more request signals for access to an output port to two or more grant arbiters;
selecting between the two or more request signals at the two or more grant arbiters based on round robin scheduling wherein the selecting between the two or more request signals generates one or more grant signals;
providing the one or more grant signals from the two or more grant arbiters to two or more accept arbiters;
selecting between grant signals at each of the two or more accept arbiters based on least recently used scheduling wherein selecting between grant signals generates an accepted grant signal; and
providing the accepted grant signal to a switch control device, wherein the accepted grant signal controls switch connections.

2. The method of claim 1, wherein the grant arbiter comprises shift registers.

3. The method of claim 1, wherein the accept arbiter comprises shift registers.

4. The method of claim 1, wherein only one grant signal is provided from each grant arbiter and only one grant signal is selected by an accept arbiter.

5. The method of claim 1, wherein the switch comprises a crossbar switch.

6. The method of claim 1, wherein the two or more request signals are generated by a virtual output queue when the virtual output queue contains data.

7. A method for selecting between granted requests provided to an arbiter in a switching system having two or more egress ports, the method comprising:
receiving two or more granted requests at the arbiter, each granted request associated with an egress port;
determining which of the two or more egress ports was least recently used, the least recently used egress port designated the highest priority egress port;
accepting the granted request associated with the highest priority egress port; and
outputting a signal responsive to the accepting of the granted request.

8. The method of claim 7, further including updating the least recently used status of the two or more egress ports in response to the accepting the granted request associated with the highest priority egress port based on a least recently used scheduling.

9. The method of claim 7, wherein the determining comprises accessing a pointer value.

10. The method of claim 7, wherein the arbiter comprises an accept arbiter in a crossbar switch scheduler, the crossbar switch scheduler including a granter arbiter and the accept arbiter.

11. The method of claim 7, wherein the signal responsive to the accepting of the granted request comprises a signal indicating that an ingress port's output queue has been selected to transmit through the switch to an egress port.

12. The method of claim 7, further including repeating the steps of receiving, determining, accepting and outputting prior to a switching event.

13. A switch comprising:
two or more input ports configured to receive data;
two or more output ports, configured to transmit data;
a crossbar matrix configured to selectively connect an input port to an output port based on control signals; and
a scheduler configured to generate the control signals to thereby determine which input port connects to which output port during a switching event of the crossbar matrix, the scheduler comprising:
two or more queues configured to store data directed to one or the two or more output ports, wherein a queue is configured to generate a request signal when data is stored in the queue;
at least one first arbiter configured to receive one or more request signals and select a request signal from two or more request signals and output a grant signal indicative of the selected request signal; and
at least one second arbiter configured to receive two or more grant signals and generate a selected grant signal designating an output port based on least recently used arbitration.

14. The switch of claim 13, further including a decision register configured to receive a selected grant signal from the at least one second arbiter and output control signals to the crossbar matrix to control a switching event.

15. The switch of claim 13, wherein the first arbiter comprises a grant arbiter and the second arbiter comprises an accept arbiter.

16. The switch of claim 13, wherein the scheduler comprises a first arbiter associated with each input port and a second arbiter associated with each output port.

17. The switch of claim 13, wherein the request signal comprises a signal from a queue associated with an output port to send data from the queue through the switch to the output port and a grant signal comprises a signal from the first arbiter indicating which output port was selected by a first arbiter to receive data from the queue.

18. A switch scheduling system configured to a control data flow through a switch by controlling switch connections between two or more inputs and two or more outputs, the scheduling system comprising:
two or more queues, wherein at least one of the two or more queues are configure to store data and generate a request when data is stored in a queue;
a first memory configured to store one or more requests from the two or more queues to transmit to an output;
a group of first arbiters, wherein each of the first arbiters is configured to receive request signals from the first memory and select a request based on round robin selection, wherein each of the first arbiters are configured to output a grant signal representative of a queue associated with an output;
a group of second arbiters, wherein each of the second arbiters is configured to receive one or more grant signals from the group of first arbiters and select a grant signal based on least recently used selection, wherein the selected grant signal represents the least recently selected output; and
an interface module configured to receive an indictor of the selected grant signals of the group of second arbiters and provide control signals to a switch.

19. The system of claim 18, wherein at least one queue is associated with an output of the switch and at least one queue is configured as a first-in, first-out device.

20. The system of claim 18, wherein a first arbiter is associated with each input and a second arbiter is associated with each output.

21. The system of claim 18, wherein the switch comprises a crossbar switch.

22. The system of claim 18, wherein the each of the two or more queues comprise virtual output queues and each virtual output queue is associated with a output.

23. The system of claim 18, wherein the first memory stores a request vector.

24. A least recently used arbiter configured for use in a scheduler configured to determine input to output connections in a switch:
a first memory configured to store a grant vector;
a least one least recently used priority arbiter comprising:
one or more inputs configured to receive the grant vector from the first memory;
one or more second memories configured to store pointer values; and
an arbiter controller configured to updated the pointer values based on least recently used arbitration and generate an accept vector; and
decoder configured to receive the accept vector from the at least one least recently used priority arbiter and, responsive to the accept vector, output one or more switch control signals.

25. The arbiter of claim 24, wherein the accept vector is a value associated with an output.

26. The arbiter of claim 24, wherein the switch comprises a crossbar switch.

27. The arbiter of claim 24, wherein the first memory comprises one or more registers and the one or more second memories comprises shift registers.

28. The arbiter of claim 24, wherein the arbiter controller is configured to selectively arrange the pointer values based on which output was least recently accepted and generate an accept vector indicating which position of the grant vector was accepted.

29. A system for controlling connection of two or more ingress ports with two or more egress ports of a switch, the system comprising:
means for requesting a connection to an egress port;
means for receiving two or more requests;
means for selecting one request of the two or more requests to an egress port;
means for communicating which one request was selected by sending a grant signal;
means for receiving two or more grant signals;
means for selecting one grant signal from the two or more received grant signals, the selecting based on a least recently selected basis; and
means for communicating which one grant signal was selected by sending an accept signal to a switch controller.

30. The system of claim 29, wherein a grant signal represents a selected request to transmit to an egress port and an accept signal represents which selected request is allowed a connection to an egress port.

31. The system of claim 29, wherein the means for requesting a connection comprises a queue.

32. The system of claim 29, wherein during one or more iterations the least recently selected basis is updated.

33. The system of claim 32, wherein the least recently selected basis controls the means for selecting one grant signal to selected a grant signal representing the least recently utilized egress port.
